(19) United States
(12) Patent Application Publication
(10) Pub. No.: US 2024/0313482 A1
(43) Pub. Date: Sep. 19, 2024

(54) SHIELDED ELECTRICALLY CONDUCTIVE PATH

(71) Applicants: AUTONETWORKS TECHNOLOGIES, LTD., Mie (JP); SUMITOMO WIRING SYSTEMS, LTD., Mie (JP); SUMITOMO ELECTRIC INDUSTRIES, LTD., Osaka (JP)

(72) Inventor: Kazuaki HAMADA, Osaka (JP)

(21) Appl. No.: 18/576,096

(22) PCT Filed: Jun. 17, 2022
(86) PCT No.: PCT/JP2022/024362

§ 371 Date: Jan. 2, 2024

(30) Foreign Application Priority Data
Jul. 7, 2021 (JP) 2021-112601

(51) Int. Cl. H01R 13/6592; H01R 4/18; H01R 13/639

(52) U.S. Cl. CPC H01R 13/6592; H01R 4/183; H01R 13/639

(57) ABSTRACT

A sleeve surrounds an exposed part extending forward of the sheath, out of the shield layer, and is crimped to an outer peripheral surface of the insulation coating. A crimping portion of an outer conductor of a shield terminal is crimped to the sleeve while surrounding the sleeve and a region behind the sleeve, out of the insulation coating. An inner peripheral side locking portion and an outer peripheral side locking portion are formed in a region covering the insulation coating, out of the crimping portion. The inner peripheral side locking portion is located more radially inward than a region surrounding the sleeve, out of the crimping portion. The outer peripheral side locking portion is locked to the inner peripheral side locking portion while being accommodated in a recess in an outer peripheral surface of the inner peripheral side locking portion.

### TECHNICAL FIELD

The present disclosure relates to a shielded electrically conductive path.

### BACKGROUND

Patent Document 1 discloses a structure for crimping a U-shaped crimping portion formed in an outer conductor terminal to the outer periphery of a shield conductor of a shielded cable. A first hook-like piece bent into a folded shape is formed on one end part of the crimping portion, and a second hook-like piece bent into a folded shape is formed on the other end part of the crimping portion. With the crimping portion crimped to the shielded cable, expansion deformation of the crimping portion is prevented by the engagement of the first and second hook-like pieces.

### PRIOR ART DOCUMENT

### Patent Document

Patent Document 1: JP 2014-060105 A

### SUMMARY OF THE INVENTION

### Problems to be Solved

Since the first hook-like piece having the folded shape and the second hook-like piece having the folded shape are so engaged that four layers overlap in a radial direction, there is a problem that a crimped part by the crimping portion is enlarged in the radial direction.

A shielded electrically conductive path of the present disclosure was completed on the basis of the above situation and aims to reduce a diameter.

### Means to Solve the Problem

The present disclosure is directed to a shielded electrically conductive path with a shielded cable including an insulation coating surrounding a core wire, a shield layer surrounding the insulation coating and a sheath surrounding the shield layer, a sleeve surrounding an exposed part extending forward of the sheath, out of the shield layer, the sleeve being crimped to an outer peripheral surface of the insulation coating, and a shield terminal including an outer conductor, a crimping portion in the form of an open barrel formed in a rear end part of the outer conductor being crimped to the sleeve while surrounding the sleeve and a region behind the sleeve, out of the insulation coating, an inner peripheral side locking portion and an outer peripheral side locking portion being formed in a region covering the insulation coating, out of the crimping portion, the inner peripheral side locking portion being located more radially inward than a region surrounding the sleeve, out of the crimping portion, and the outer peripheral side locking portion being locked to the inner peripheral side locking portion while being accommodated in a recess in an outer peripheral surface of the inner peripheral side locking portion.

### Effect of the Invention

According to the present disclosure, a diameter can be reduced.

### BRIEF DESCRIPTION OF THE DRAWINGS

FIG. 1 is a plan view of a shielded electrically conductive path of a first embodiment.

FIG. 2 is a section along X-X of FIG. 1.

FIG. 3 is a section along Y-Y of FIG. 1.

FIG. 4 is a perspective view showing the form of a crimping portion before crimping.

FIG. 5 is a partial development of the crimping portion.

FIG. 6 is a section along Y-Y of a shielded electrically conductive path of a second embodiment.

FIG. 7 is a section along Y-Y of a shielded electrically conductive path of a third embodiment.

FIG. 8 is a section along Y-Y of a shielded electrically conductive path of a fourth embodiment.

FIG. 9 is a partial plan view of a shielded electrically conductive path of a fifth embodiment.

FIG. 10 is a section along Z-Z of FIG. 9.

### DETAILED DESCRIPTION TO EXECUTE THE INVENTION

### Description of Embodiments of Present Disclosure

First, embodiments of the present disclosure are listed and described.
(1) The shielded electrically conductive path of the present disclosure is provided with a shielded cable including an insulation coating surrounding a core wire, a shield layer surrounding the insulation coating and a sheath surrounding the shield layer, a sleeve surrounding an exposed part extending forward of the sheath, out of the shield layer, the sleeve being crimped to an outer peripheral surface of the insulation coating, and a shield terminal including an outer conductor, a crimping portion in the form of an open barrel formed in a rear end part of the outer conductor being crimped to the sleeve while surrounding the sleeve and a region behind the sleeve, out of the insulation coating, an inner peripheral side locking portion and an outer peripheral side locking portion being formed in a region covering the insulation coating, out of the crimping portion, the inner peripheral side locking portion being located more radially inward than a region surrounding the sleeve, out of the crimping portion, and the outer peripheral side locking portion being locked to the inner peripheral side locking portion while being accommodated in a recess in an outer peripheral surface of the inner peripheral side locking portion. In the shielded electrically conductive path of the present disclosure, the inner peripheral side locking portion is located more radially inward than the region surrounding the sleeve, out of the crimping portion, and the outer peripheral side locking portion is accommodated in the recess in the outer peripheral surface of the inner peripheral side locking portion. Thus, a diameter can be reduced as compared to the case where the inner peripheral side locking portion and the recess are not formed in the crimping portion.
(2) Preferably, the crimping portion is formed with a retaining portion arranged at a position in contact with the sleeve from behind or closely facing the sleeve from behind. According to this configuration, when a rearward tensile load is applied to the shielded cable, the rear end of the sleeve is locked to the retaining portion, whereby the shielded cable can be prevented from being relatively displaced rearward with respect to the shield terminal.
(3) Preferably in (2), the retaining portion continuously extends over at least more than a semiperimeter in a circumferential direction. According to this configuration, when a rearward tensile load is applied to the shielded cable, a rearward relative displacement of the shielded cable with respect to the shield terminal can be reliably prevented.
(4) Preferably in (2) or (3), the inner peripheral side locking portion is formed in the retaining portion. According to this configuration, the shape of the crimping portion can be simplified as compared to the case where the inner peripheral side locking portion is formed in a part different from the retaining portion.
(5) Preferably, a depth of the recess is equal to or larger than a plate thickness of the crimping portion. According to this configuration, since the entire outer peripheral side locking portion is accommodated into the recess, it can be avoided that the outer peripheral side locking portion partially protrudes from the outer peripheral surface of the crimping portion.
(6) Preferably, one of the inner peripheral side locking portion and the outer peripheral side locking portion is formed with a locking hole, and the other of the inner peripheral side locking portion and the outer peripheral side locking portion is formed with a locking protrusion to be locked into the locking hole. According to this configuration, the opening of the crimping portion is prevented by locking the locking protrusion to the hole edge of the locking hole.
(7) Preferably in (6), an opening dimension in a front-rear direction of the locking hole is set to be larger than a dimension in the front-rear direction of the locking protrusion. According to this configuration, even if dimensional tolerances and assembly tolerances during crimping of the crimping portion are large, the locking hole and the locking protrusion can be reliably locked.
(8) Preferably in (6) or (7), an opening dimension in a circumferential direction of the locking hole is set to be larger than a dimension in the circumferential direction of the locking protrusion. According to this configuration, even if dimensional tolerances and assembly tolerances during crimping of the crimping portion are large, the locking hole and the locking protrusion can be reliably locked.
(9) Preferably in (6) to (8), the locking hole is formed in the inner peripheral side locking portion, and the locking protrusion is formed on the outer peripheral side locking portion. According to this configuration, since a locked part of the hole edge of the locking hole and the locking protrusion is covered by the outer peripheral side locking portion, the interference of an external matter with the locked part of the locking hole and the locking protrusion can be prevented.
(10) Preferably in (6) to (8), the locking protrusion is shaped by bending a part of the inner peripheral side locking portion or the outer peripheral side locking portion into a folded shape. This configuration corresponds to first and second embodiments. According to this configuration, the locking strength of the locking protrusion is higher as compared to a locking protrusion formed by bending a tip edge part of the inner peripheral side locking portion or the outer peripheral side locking portion at a right angle.
(11) Preferably in (6) to (8), the locking protrusion is shaped by cutting and raising a part of the inner peripheral side locking portion or the outer peripheral side locking portion in a plate thickness direction. This configuration corresponds to third and fourth embodiments. According to this configuration, a material cost can be reduced as compared to the case where a part flush with and extending from the outer peripheral edge of the inner peripheral side locking portion or the outer peripheral side locking portion is bent.
(12) Preferably in (6) to (8), the locking protrusion is shaped by bending the inner peripheral side locking portion or the outer peripheral side locking portion along a fold line in a circumferential direction. This configuration corresponds to a fifth embodiment. According to this configuration, since the locking protrusion has high rigidity against an external force acting in the circumferential direction, expansion deformation of the crimping portion due to the deformation of the locking protrusion can be prevented.

### Details of Embodiments of Present Disclosure

### First Embodiment

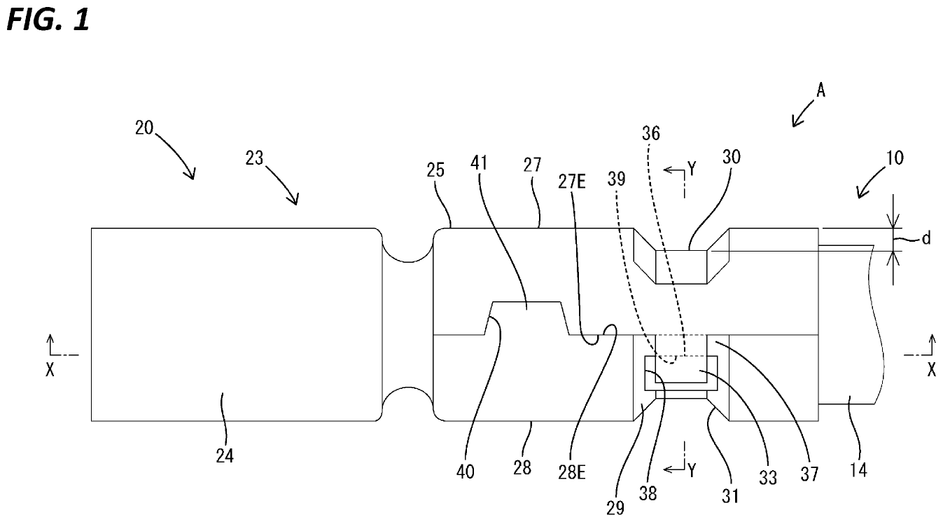

A first specific embodiment of the present disclosure is described with reference to FIGS. 1 to 5. Note that the present invention is not limited to these illustrations, but is represented by claims and intended to include all changes in the scope of claims and in the meaning and scope of equivalents. In the following description, a left side in FIGS. 1, 2 and 4 is defined as a front side concerning a front-rear direction. The front-rear direction is used as a synonym for an axial direction.

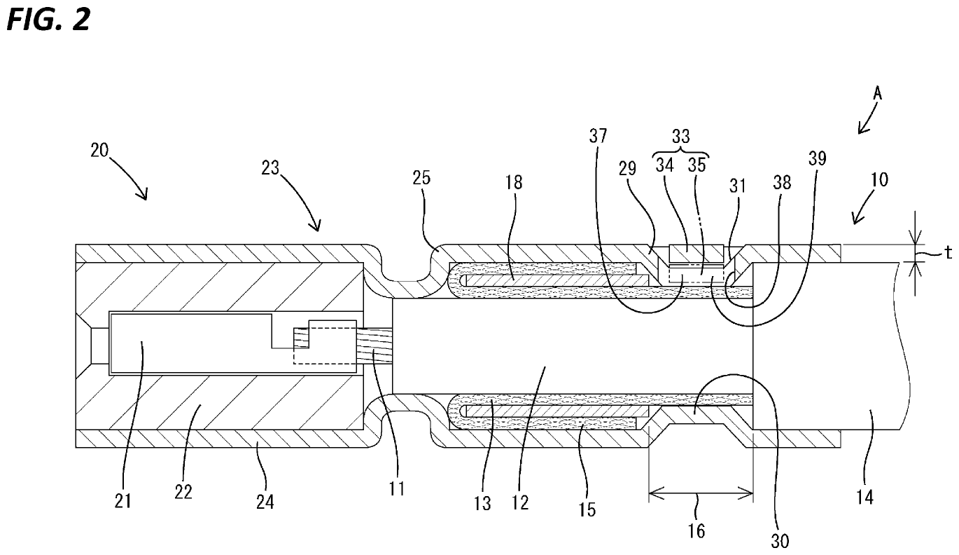

As shown in FIGS. 1 and 2, a shielded electrically conductive path A of the first embodiment is provided with a shielded cable 10, a sleeve 18 externally fit to the shielded cable 10 and a shield terminal 20 connected to a front end part of the shielded cable 10 using the sleeve 18.

The shielded cable 10 is formed such that a core wire 11 is surrounded with an insulation coating 12, a tubular shield layer 13 is overlaid on the outer periphery of the insulation coating 12, and the outer periphery of the shield layer 13 is surrounded with a sheath 14. The shield layer 13 is constituted by a braided wire. The front end part of the shielded cable 10 is arranged with an axial direction oriented in the front-rear direction. As shown in FIG. 2, in the front end part of the shielded cable 10, the sheath 14 is removed, and the core wire 11, the insulation coating 12 and the shield layer 13 are exposed in front of the sheath 14. In front of the sheath 14, the insulation coating 12 is partially removed and the core wire 11 is exposed in front of the insulation coating 12.

The sleeve 18 is externally fit on a region behind the front end of the insulation coating 12, out of the outer peripheral surface of the shield layer 13. The sleeve 18 surrounds the shield layer 13 and the insulation coating 12. A front end part of the shield layer 13 is folded rearward and covers the outer periphery of the sleeve 18. A region surrounding the sleeve 18, out of the shield layer 13, is defined as a folded portion 15. The rear end of the folded portion 15 is located slightly in front of the rear end of the sleeve 18. The front end of the sleeve 18 is located slightly behind the front end of the insulation coating 12. The rear end of the sleeve 18 is located in front of the front end of the sheath 14. Out of the shielded cable 10, a region between the front end of the sheath 14 and the rear end of the sleeve 18 is defined as a function portion 16 having a smaller diameter than the sheath 14 and the folded portion 15.

As shown in FIG. 2, the shield terminal 20 is provided with an inner conductor 21 connected to a front end part of the core wire 11, a dielectric 22 accommodating the inner conductor 21 and an outer conductor 23 mounted on the dielectric 22 while surrounding the outer periphery of the dielectric 22. The outer conductor 23 includes a tubular body portion 24 constituting a front end part of the outer conductor 23 and a hollow cylindrical crimping portion 25 continuous with the rear end of the body portion 24 and constituting a rear end part of the outer conductor 23. An axial direction of the outer conductor 23 is coaxial with the axial direction of the shielded cable 10 and oriented in the front-rear direction. The inner conductor 21 and the dielectric 22 are accommodated in the body portion 24.

The crimping portion 25 is a part for fixing the outer conductor 23 to the outer peripheral surface of the shielded cable 10. By crimping the crimping portion 25 to the shielded cable 10, the front end part of the shielded cable 10 and a rear end part of the shield terminal 20 are connected with separation in the axial direction restricted, and the outer conductor 23 and the shield layer 13 are conductively connected.

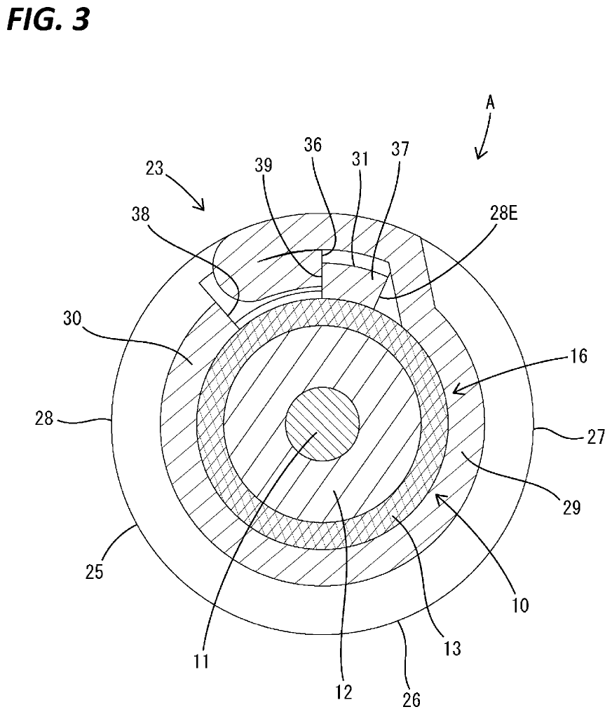

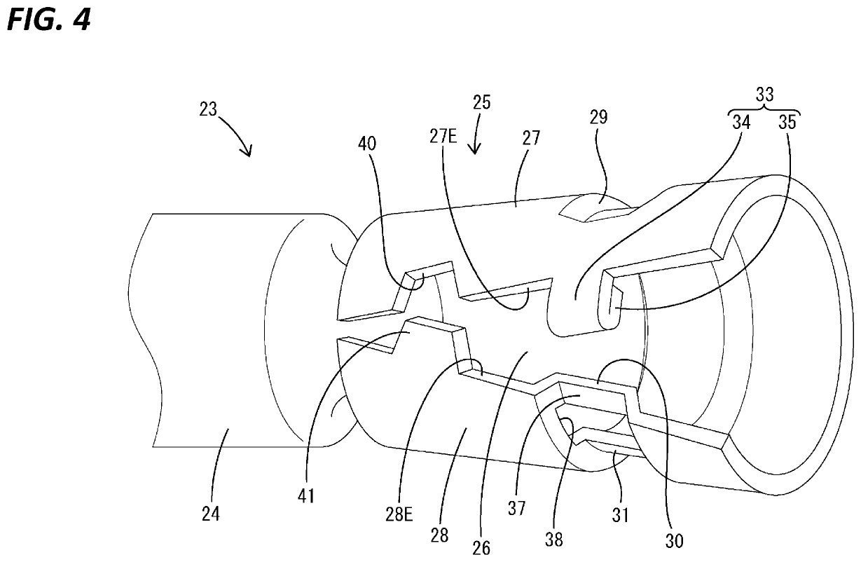

As shown in FIGS. 2 to 4, the crimping portion 25 includes a base plate portion 26 extending rearward from the rear end of the body portion 24, a first crimping portion 27 extending in one direction (counterclockwise direction in FIG. 3) along a circumferential direction from the base plate portion 26 and a second crimping portion 28 extending in a direction (clockwise direction in FIG. 3) opposite to the first crimping portion 27 along the circumferential direction from the base plate portion 26. As shown in FIG. 4, in a state where the crimping portion 25 is not crimped to the shielded cable 10, the crimping portion 25 has a tapered shape to be gradually expanded in diameter from a front end toward a rear end. A first extending end edge 27E, which is an edge part on a tip side in an extending direction of the first crimping portion 27, and a second extending end edge 28E, which is an edge part on a tip side in an extending direction of the second crimping portion 28, are separated in the circumferential direction.

Out of the crimping portion 25, a region surrounding the function portion 16 in the front-rear direction is formed with a retaining portion 29 extending in the circumferential direction. The retaining portion 29 is formed by striking a part of the crimping portion 25 radially inward. A bottom plate portion 30 of the retaining portion 29 projects further toward an inner peripheral side than a region surrounding the sheath 14, the folded portion 15 and the sleeve 18, out of the crimping portion 25. A recess 31 extending in the circumferential direction is formed in the outer peripheral surface of the retaining portion 29. A formation region of the retaining portion 29 in the circumferential direction is a range from a position closer to the base plate portion 26 than the first extending end edge 27E to the second extending end edge 28E. In a crimped state of the crimping portion 25, the retaining portion 29 continuously extends in a large part in the circumferential direction, i.e. over a region at least more than a semiperimeter.

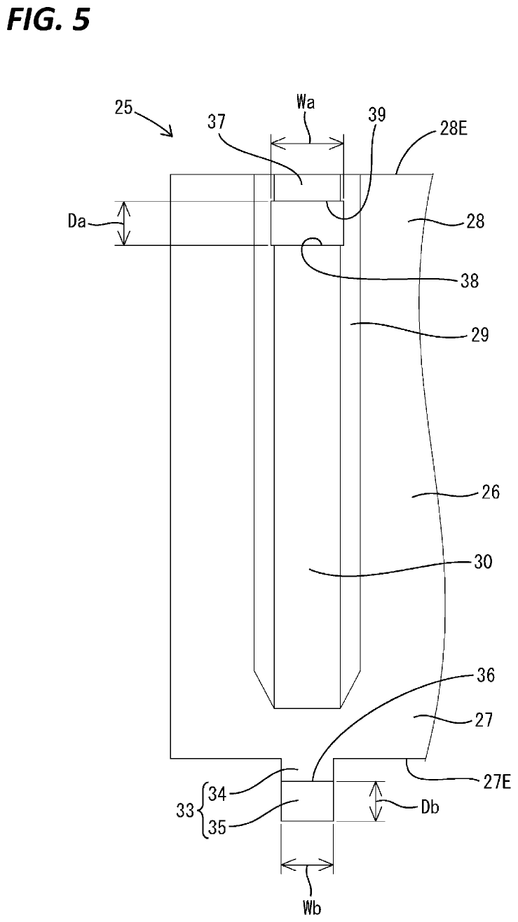

The first crimping portion 27 is integrally formed with an outer peripheral side locking portion 33. As shown in FIG. 4, the outer peripheral side locking portion 33 projects in the circumferential direction from the first extending end edge 27E toward the second extending end edge 28E. As shown in FIG. 5, the outer peripheral side locking portion 33 is located on an extension of the retaining portion 29. That is, the outer peripheral side locking portion 33 is arranged in a region surrounding the function portion 16, out of the first crimping portion 27. The outer peripheral side locking portion 33 includes a base portion 34 flush with and projecting from the first crimping portion 27, and a locking protrusion 35 folded radially inward from the projecting end of the base portion 34. The outer peripheral surface of the base portion 34 and that of the first crimping portion 27 are smoothly continuous, and the inner peripheral surface of the base portion 34 and that of the first crimping portion 27 are smoothly continuous.

The locking protrusion 35 is arranged to overlap on the inner peripheral surface of the base portion 34, and located more radially inward than the base portion 34. The locking protrusion 35 is in the form of a projection projecting radially inward from the first crimping portion 27. A width in the axial direction of the locking protrusion 35 is equal to that of the base portion 34. The locking protrusion 35 has a first locking surface 36 facing in a direction opposite to a projection direction of the base portion 34 along the circumferential direction.

Out of the retaining portion 29, a region near the second extending end edge 28E functions as an inner peripheral side locking portion 37. The inner peripheral side locking portion 37 includes a rectangular locking hole 38 penetrating through the retaining portion 29 from an outer peripheral side to an inner peripheral side. Out of an inner peripheral surface along an opening edge of the locking hole 38, an inner surface parallel to the axial direction and near the second extending end edge 28E in the circumferential direction functions as a second locking surface 39.

As shown in FIGS. 1 and 4, a first displacement restricting portion 40 is formed in a region forward of the outer peripheral side locking portion 33, out of the first extending end edge 27E. The first displacement restricting portion 40 is formed by cutting the first extending end edge 27E in the circumferential direction. A second displacement restricting portion 41 is formed in a region forward of the retaining portion 29 and the inner peripheral side locking portion 37, out of the second extending end edge 28E. The second displacement restricting portion 41 is shaped to project in the circumferential direction from the second extending end edge 28E.

The crimping portion 25 is crimped to the shielded cable 10 by setting the crimping portion 25 and the front end part of the shielded cable 10 in an applicator (not shown). In a crimping step, the first and second crimping portions 27, 28 are reduced in diameter and deformed, and crimped to wind around the outer periphery of the shielded cable 10. With the crimping portion 25 crimped to the shielded cable 10, a region forward of the outer peripheral side locking portion 33, the retaining portion 29 and the inner peripheral side locking portion 37, out of the crimping portion 25, is crimped to the outer peripheral surfaces of the sleeve 18 and the folded portion 15, and the folded portion 15 is radially sandwiched between the sleeve 18 and the crimping portion 25. In this way, the folded portion 15, the sleeve 18 and the crimping portion 25 are conductively fixed in an integrated state.

With the crimping portion 25 crimped to the shielded cable 10, the outer peripheral side locking portion 33, the retaining portion 29 and the inner peripheral side locking portion 37 surround the function portion 16. Since an outer diameter of the function portion 16 is smaller than those of the sheath 14 and the folded portion 15, the inner peripheral surface of the bottom plate portion 30 of the retaining portion 29 comes into contact with the outer peripheral surface of the function portion 16 or is in contact with the outer peripheral surface of the function portion 16. The outer peripheral side locking portion 33 is accommodated into the recess 31 in the outer peripheral surface of the retaining portion 29 and overlaid on the outer peripheral surface of the inner peripheral side locking portion 37. The locking protrusion 35 of the outer peripheral side locking portion 33 is accommodated into the locking hole 38 of the inner peripheral side locking portion 37, and the first and second locking surfaces 36, 39 come into contact and are locked in the circumferential direction. By the locking of the first and second locking surfaces 36, 39, the crimping portion 25 is prevented from being opened and deformed in the circumferential direction, and the crimping portion 25 is reliably fixed to the outer periphery of the shielded cable 10.

The front end of the retaining portion 29 is arranged at a position in contact with the rear end of the sleeve 18 from behind or closely facing the rear end of the sleeve 18 from behind. In this way, when the shielded cable 10 is pulled rearward with respect to the shield terminal 20, the rear end of the sleeve 18 is caught by the front end of the retaining portion 29. Therefore, the shielded cable 10 and the shield terminal 20 are reliably held in a fixed state without being separated in the axial direction.

The first and second displacement restricting portions 40, 41 are fit at a position of the crimping portion 25 forward of the outer peripheral side locking portion 33 and the inner peripheral side locking portion 37, thereby restricting relative displacements of the first and second crimping portions 27, 28 in the axial direction. Since the outer peripheral side locking portion 33 is accommodated in the recess 31 of the retaining portion 29, the outer peripheral surface of the outer peripheral side locking portion 33 does not project radially outward from the outer peripheral surface of a region of the crimping portion 25 where the retaining portion 29 is not formed.

The shielded electrically conductive path A of the first embodiment is provided with the shielded cable 10, the sleeve 18 and the shield terminal 20. The shielded cable 10 includes the insulation coating 12 surrounding the core wire 11, the shield layer 13 surrounding the insulation coating 12 and the sheath 14 surrounding the shield layer 13. The sleeve 18 surrounds an exposed part extending forward of the sheath 14, out of the shield layer 13, and is crimped to the outer peripheral surface of the insulation coating 12. The shield terminal 20 includes the outer conductor 23. The crimping portion 25 in the form of an open barrel is formed in a rear end part of the outer conductor 23. The crimping portion 25 is crimped to the sleeve 18 while surrounding the sleeve 18 and a region behind the sleeve 18, out of the insulation coating 12.

The inner peripheral side locking portion 37 and the outer peripheral side locking portion 33 are formed in the region covering the insulation coating 12, out of the crimping portion 25. The inner peripheral side locking portion 37 is located radially inward of the region surrounding the sleeve 18, out of the crimping portion 25. The outer peripheral side locking portion 33 is locked to the inner peripheral side locking portion 37 while being accommodated in the recess 31 in the outer peripheral surface of the inner peripheral side locking portion 37. Therefore, as compared to the case where the crimping portion 25 is not formed with the inner peripheral side locking portion 37 and the recess 31, the shielded electrically conductive path A of the first embodiment can be reduced in diameter. A depth d (see FIG. 1) of the recess 31 is equal to or larger than a plate thickness t (see FIG. 2) of the crimping portion 25. According to this configuration, since the entire outer peripheral side locking portion 33 is accommodated in the recess 31, it can be avoided that the outer peripheral side locking portion 33 partially protrudes from the outer peripheral surface of the crimping portion 25.

The crimping portion 25 is formed with the retaining portion 29 arranged at the position in contact with the sleeve 18 from behind or closely facing the sleeve 18 from behind. When a rearward tensile load is applied to the shielded cable 10, the rear end of the sleeve 18 is locked to the retaining portion 29, whereby the shielded cable 10 can be prevented from being relatively displaced rearward with respect to the shield terminal 20. The retaining portion 29 continuously extends over at least more than the semiperimeter in the circumferential direction. According to this configuration, when a rearward tensile load is applied to the shielded cable 10, a rearward relative displacement of the shielded cable 10 with respect to the shield terminal 20 can be reliability prevented.

The inner peripheral side locking portion 37 of the shielded electrically conductive path A of the first embodiment is formed in the retaining portion 29. As compared to the case where the inner peripheral side locking portion 37 and the retaining portion 29 are formed in different parts, the shape of the crimping portion 25 can be simplified in the shielded electrically conductive path A of the first embodiment.

The inner peripheral side locking portion 37 is formed with the locking hole 38, and the outer peripheral side locking portion 33 is formed with the locking protrusion 35 to be locked into the locking hole 38. By locking the locking protrusion 35 to the hole edge of the locking hole 38, the opening of the crimping portion 25 is prevented. According to this configuration, since a locked part of the hole edge of the locking hole 38 and the locking protrusion 35 is covered by the outer peripheral side locking portion 33, the interference of an external matter with the locked part of the locking hole 38 and the locking protrusion 35 can be prevented. As shown in FIG. 5, an opening width Wa in the front-rear direction of the locking hole 38 is set to be larger than a dimension Wb in the front-rear direction of the locking protrusion 35. An opening dimension Da in the circumferential direction of the locking hole 38 is set to be larger than a dimension Db in the circumferential direction of the locking protrusion 35. According to this configuration, even if dimensional tolerances and assembly tolerances during crimping of the crimping portion 25 are large, the locking hole 38 and the locking protrusion 35 can be reliably locked.

The locking protrusion 35 of the first embodiment is shaped by bending a part of the outer peripheral side locking portion 33 into a folded shape. The shielded electrically conductive path A of the first embodiment has higher locking strength by the locking protrusion 35 as compared to a locking protrusion formed by bending a tip edge part of an outer peripheral side locking portion at a right angle.

### Second Embodiment

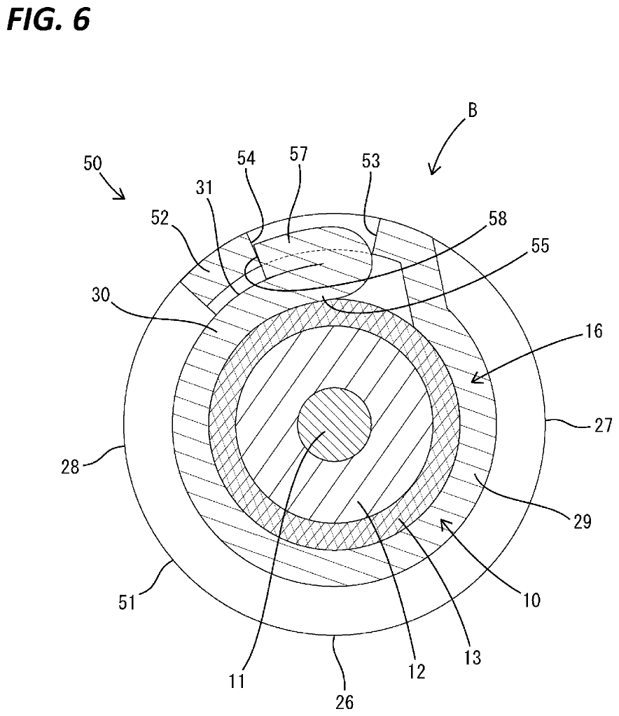

A specific second embodiment of the present disclosure is described with reference to FIG. 6. In a shielded electrically conductive path B of the second embodiment, a crimping portion 51 of an outer conductor 50 is configured to be different from that of the first embodiment. Since the other configuration is the same as in the first embodiment, the same components are denoted by the same reference signs and structures, functions and effects are not described.

The crimping portion 51 of the second embodiment includes a base plate portion 26, a first crimping portion 27 extending in one direction along a circumferential direction from the base plate portion 26 and a second crimping portion 28 extending in a direction opposite to the first crimping portion 27 along the circumferential direction from the base plate portion 26. In a state where the crimping portion 51 is not crimped to a shielded cable 10, the crimping portion 51 has a tapered shape to be gradually expanded in diameter from a front end toward a rear end. Out of the crimping portion 51, a region surrounding a function portion 16 of the shielded cable 10 in the front-rear direction is formed with a retaining portion 29 extending in the circumferential direction as in the first embodiment.

The first crimping portion 27 is integrally formed with an outer peripheral side locking portion 52. The outer peripheral side locking portion 52 projects in the circumferential direction from a first extending end edge (not shown) of the first crimping portion 27 toward a second extending end edge (not shown) of the second crimping portion 28. The outer peripheral side locking portion 52 is located on an extension of the retaining portion 29. That is, the outer peripheral side locking portion 52 is arranged in a region surrounding the function portion 16, out of the first crimping portion 27. The outer peripheral surface of the outer peripheral side locking portion 52 and that of the first crimping portion 27 are smoothly continuous, and the inner peripheral surface of the outer peripheral side locking portion 52 and that of the first crimping portion 27 are smoothly continuous. The outer peripheral side locking portion 52 includes a rectangular locking hole 53 penetrating through the outer peripheral side locking portion 52 from an outer peripheral side to an inner peripheral side. Out of an inner peripheral surface along an opening edge of the locking hole 53, an inner surface parallel to an axial direction and distant from the first extending end edge 27E (not shown) functions as a first locking surface 54.

Out of the retaining portion 29, a region near the second extending end edge 28E (not shown) functions as an inner peripheral side locking portion 55. The inner peripheral side locking portion 55 includes a locking protrusion 57 folded radially outward from the second extending end edge 28E, out of a bottom plate portion 30 of the retaining portion 29. The locking protrusion 57 is arranged to overlap on the outer peripheral surface of the bottom plate portion 30 and located more radially inward than the bottom plate portion 30. The locking protrusion 57 is in the form of a projection projecting radially outward from the bottom plate portion 30, and accommodated in a recess 31 in the outer peripheral surface of the inner peripheral side locking portion 55. The locking protrusion 57 has a second locking surface 58 facing in the circumferential direction.

With the crimping portion 51 crimped to the shielded cable 10, the outer peripheral side locking portion 52, the retaining portion 29 and the inner peripheral side locking portion 55 surround the function portion 16. Since an outer diameter of the function portion 16 is smaller than those of a sheath (not shown) and a folded portion (not show), the inner peripheral surface of the retaining portion 29 comes into contact with the outer peripheral surface of the function portion 16 or is in contact with the outer peripheral surface of the function portion 16. The outer peripheral side locking portion 52 is accommodated into the recess 31 in the outer peripheral surface of the retaining portion 29 and overlaid on the outer peripheral surface of the inner peripheral side locking portion 55. A locking protrusion 57 of the inner peripheral side locking portion 55 is accommodated into the locking hole 53 of the outer peripheral side locking portion 52, and the first and second locking surfaces 54, 58 come into contact and are locked in the circumferential direction. By the locking of the first and second locking surfaces 54, 58, the crimping portion 51 is prevented from being opened and deformed in the circumferential direction, and the crimping portion 51 is reliably fixed to the outer periphery of the shielded cable 10.

### Third Embodiment

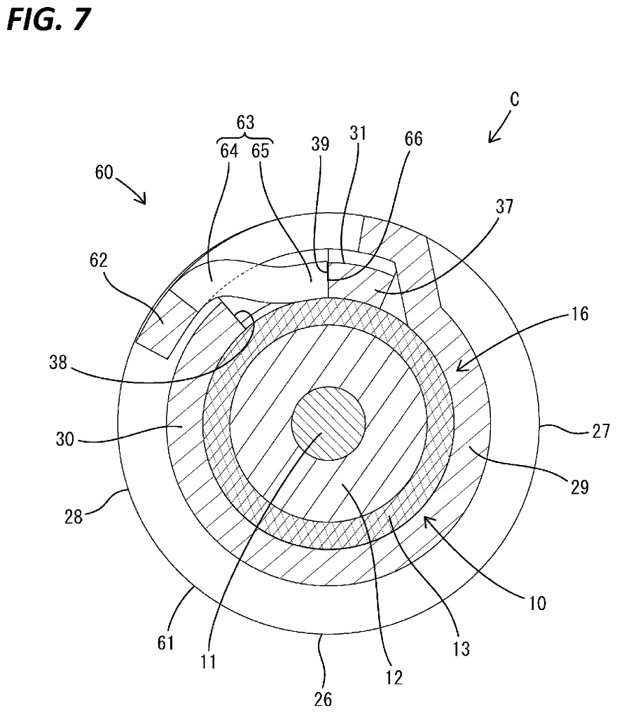

A specific third embodiment of the present disclosure is described with reference to FIG. 7. In a shielded electrically conductive path C of the third embodiment, an outer peripheral side locking portion 62 constituting a crimping portion 61 of an outer conductor 60 is configured to be different from that of the first embodiment. Since the other configuration is the same as in the second embodiment, the same components are denoted by the same reference signs and structures, functions and effects are not described.

The outer peripheral side locking portion 62 of the third embodiment includes a locking protrusion 63 formed by cutting and raising a part of the outer peripheral side locking portion 62 of a first crimping portion 27 toward a radially inner peripheral side. The locking protrusion 63 includes a bent portion 64 and a butting portion 65. The bent portion 64 projects in the circumferential direction from a tip side toward a base end side of the outer peripheral side locking portion 62. The bent portion 64 is bent to project further radially inward than a tip part of the outer peripheral side locking portion 62. The butting portion 65 extends in the circumferential direction from the projecting end of the bent portion 64. A radially inward projecting dimension of the butting portion 65 from the outer peripheral side locking portion 62 is equal to a plate thickness of an inner peripheral side locking portion 37. The extending end surface of the butting portion 65 functions as a first locking surface 66 orthogonal to the circumferential direction.

With the crimping portion 61 crimped to a shielded cable 10, the outer peripheral side locking portion 62 is accommodated in a recess 31 of a retaining portion 29 and overlaid on the outer periphery of the inner peripheral side locking portion 37. A part of the locking protrusion 63 is inserted into a locking hole 38 of the inner peripheral side locking portion 37. That is, a part of the bent portion 64 and the entire butting portion 65 are accommodated into the locking hole 38. The first locking surface 66 comes into contact with a second locking surface 39 of the locking hole 38 in the circumferential direction, and the first and second locking surfaces 66, 39 are locked. By this locking action, expansion deformation of the crimping portion 61 is prevented and the crimping portion 61 is held in a state crimped to the shielded cable 10.

The locking protrusion 63 is shaped by cutting and raising a part of the outer peripheral side locking portion 62 in a plate thickness direction of the outer peripheral side locking portion 62. The shielded electrically conductive path C of the third embodiment can reduce a material cost as compared to the case where a part flush with and extending from the outer peripheral edge of the outer peripheral side locking portion 62 is bent.

### Fourth Embodiment

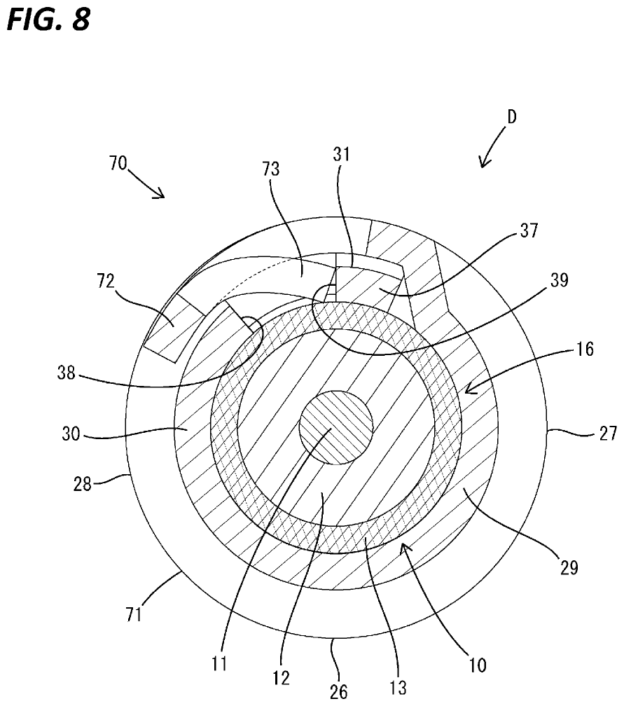

A specific fourth embodiment of the present disclosure is described with reference to FIG. 8. In a shielded electrically conductive path D of the fourth embodiment, an outer peripheral side locking portion 72 constituting a crimping portion 71 of an outer conductor 70 is configured to be different from that of the first embodiment. Since the other configuration is the same as in the first embodiment, the same components are denoted by the same reference signs and structures, functions and effects are not described.

The outer peripheral side locking portion 72 of the fourth embodiment includes a locking protrusion 73 formed by cutting and raising a part of a first crimping portion 27 toward a radially inner peripheral side. The locking protrusion 73 projects in the circumferential direction from a tip side toward a base end side of the outer peripheral side locking portion 72. A radially inward projecting dimension of the locking protrusion 73 from the outer peripheral side locking portion 72 is equal to a plate thickness of an inner peripheral side locking portion 37.

With the crimping portion 71 crimped to a shielded cable 10, the outer peripheral side locking portion 72 is accommodated in a recess 31 of a retaining portion 29 and overlaid on the outer periphery of the inner peripheral side locking portion 37. A part of the locking protrusion 73 is accommodated into a locking hole 38 of the inner peripheral side locking portion 37, and the projecting end edge of the locking protrusion 73 is locked to a second locking surface 39 of the locking hole 38 in the circumferential direction while being held in line contact therewith. By this locking action, expansion deformation of the crimping portion 71 is prevented and the crimping portion 71 is held in a state crimped to the shielded cable 10.

The locking protrusion 73 is shaped by cutting and raising a part of the outer peripheral side locking portion 72 in a plate thickness direction of the outer peripheral side locking portion 72. According to this configuration, the shielded electrically conductive path D of the fourth embodiment can reduce a material cost as compared to the case where a part flush with and extending from the outer peripheral edge of the outer peripheral side locking portion 72 is bent.

### Fifth Embodiment

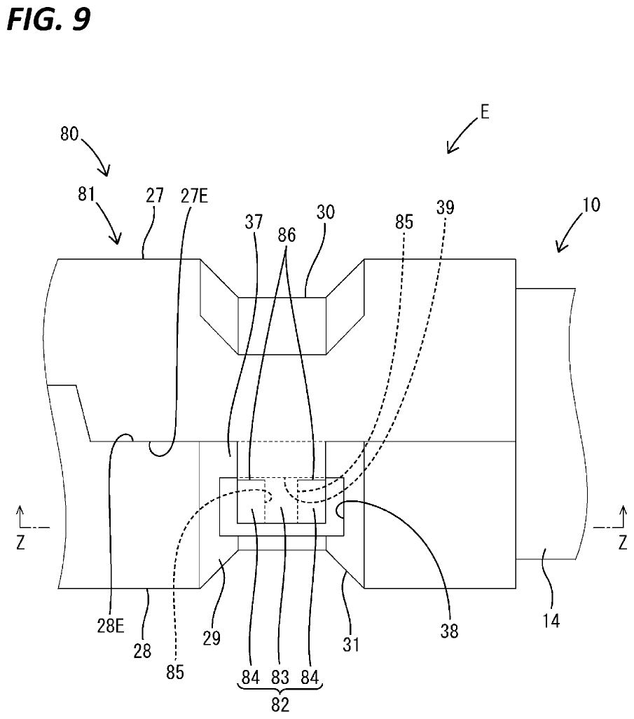

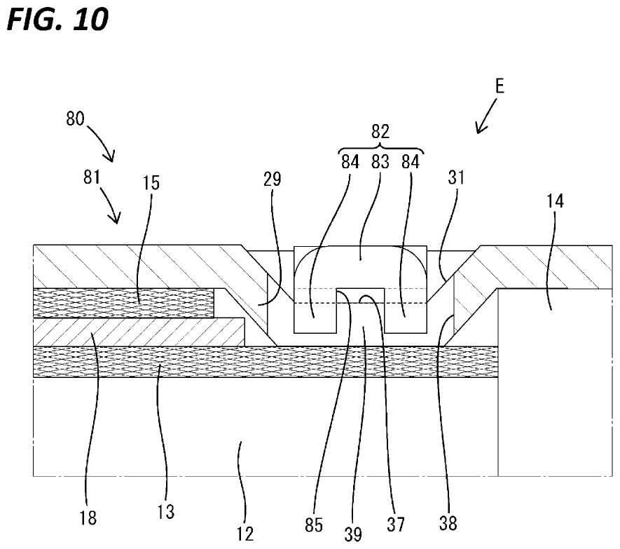

A specific fifth embodiment of the present disclosure is described with reference to FIGS. 9 to 10. In a shielded electrically conductive path E of the fifth embodiment, an outer peripheral side locking portion 82 constituting a crimping portion 81 of an outer conductor 80 is configured to be different from that of the first embodiment. Since the other configuration is the same as in the first embodiment, the same components are denoted by the same reference signs and structures, functions and effects are not described.

The outer peripheral side locking portion 82 of the fifth embodiment includes a base portion 83 and a pair of front and rear locking protrusions 84. The base portion 83 is flush with a first crimping portion 27 and projects from a first extending end edge 27E in the circumferential direction. The pair of locking protrusions 84 are formed by bending front and rear edge parts of the base portion 83 at a right angle to the base portion 83. A boundary line between the base portion 83 and the locking protrusion 84, i.e. a fold line 85 of the locking protrusion 84, extends along the circumferential direction. The locking protrusion 84 projects further radially inward than the inner peripheral surface of the first crimping portion 27. A radial projecting dimension of the locking protrusion 84 is equal to plate thicknesses of a second crimping portion 28 and an inner peripheral side locking portion 37. The locking protrusion 84 is arranged at a position separated from the first extending end edge 27E in the circumferential direction, i.e. in a region on a projecting end side of the base portion 83. A surface of the locking protrusion 84 facing the first extending end edge 27E functions as a first locking surface 86 orthogonal to the circumferential direction.

With the crimping portion 81 crimped to a shielded cable 10, the outer peripheral side locking portion 82 is accommodated in a recess 31 of a retaining portion 29 and overlaid on the outer periphery of the inner peripheral side locking portion 37. The pair of front and rear locking protrusions 84 are accommodated into a locking hole 38 of the inner peripheral side locking portion 37, and the first locking surfaces 86 of the locking protrusions 84 are locked to a second locking surface 39 of the locking hole 38 in the circumferential direction. By this locking action, expansion deformation of the crimping portion 81 is prevented and the crimping portion 81 is held in a state crimped to the shielded cable 10.

Since the locking protrusions 84 are shaped by bending the outer peripheral side locking portion 82 along the fold lines 85 in the circumferential direction, the locking protrusions 84 have high rigidity against an external force acting in the circumferential direction. Therefore, the shielded electrically conductive path E of the fifth embodiment can prevent expansion deformation of the crimping portion 81 due to the deformation of the locking protrusions 84.

### Other Embodiments

The present invention is not limited to the above described and illustrated embodiments, but is represented by claims. The present invention is intended to include all changes in the scope of claims and in the meaning and scope of equivalents and also include the following embodiments.

Although one retaining portion continuously extends in the circumferential direction in the above first to fifth embodiments, a plurality of retaining portions may be arranged at intervals in the circumferential direction and the retaining portion closest to the outer peripheral side locking portion in the circumferential direction may be formed with an inner peripheral side locking portion.

Although the retaining portion extends over a large part (region at least more than the semiperimeter) in the circumferential direction in the above first to fifth embodiments, the retaining portion may be formed only in a minimum necessary region to be locked to the outer peripheral side locking portion.

Although the inner peripheral side locking portion is formed in the retaining portion in the above first to fifth embodiments, the inner peripheral side locking portion may be formed in a part different from the retaining portion.

Although the front end part of the shield layer is folded rearward and serves as the folded portion surrounding the outer peripheral surface of the sleeve in the above first to fifth embodiments, the front end part of the shield layer may not be folded.

Although the crimping portion surrounds the outer peripheral surface of the sheath in the above first to fifth embodiments, the crimping portion may not surround the outer peripheral surface of the sheath.

Although the shield layer is constituted by a braided wire in the above first to fifth embodiments, the shield layer may be a metal foil.

In the third to fifth embodiments, the locking protrusion(s) may be formed on the inner peripheral side locking protrusion and the locking hole may be formed in the outer peripheral side locking portion.

### LIST OF REFERENCE NUMERALS

A . . . shielded electrically conductive path
B . . . shielded electrically conductive path
C . . . shielded electrically conductive path
D . . . shielded electrically conductive path
E . . . shielded electrically conductive path
Da . . . opening dimension in circumferential direction of locking hole
Db . . . dimension in circumferential direction of locking protrusion
Wa . . . opening dimension in front-rear direction of locking hole
Wb . . . dimension in front-rear direction of locking protrusion
d . . . depth of recess
t . . . plate thickness of crimping portion
10 . . . shielded cable
11 . . . core wire
12 . . . insulation coating
13 . . . shield layer
14 . . . sheath
15 . . . folded portion
16 . . . function portion
18 . . . sleeve
20 . . . shield terminal
21 . . . inner conductor
22 . . . dielectric
23 . . . outer conductor
24 . . . body portion
25 . . . crimping portion
26 . . . base plate portion
27 . . . first crimping portion
27E . . . first extending end edge
28 . . . second crimping portion
28E . . . second extending end edge
29 . . . retaining portion
30 . . . bottom plate portion
31 . . . recess
33 . . . outer peripheral side locking portion
34 . . . base portion
35 . . . locking protrusion
36 . . . first locking surface
37 . . . inner peripheral side locking portion
38 . . . locking hole
39 . . . second locking surface
40 . . . first displacement restricting portion
41 . . . second displacement restricting portion
50 . . . outer conductor
51 . . . crimping portion
52 . . . outer peripheral side locking portion
53 . . . locking hole
54 . . . first locking surface
55 . . . inner peripheral side locking portion
57 . . . locking protrusion
58 . . . second locking surface
60 . . . outer conductor
61 . . . crimping portion
62 . . . outer peripheral side locking portion
63 . . . locking protrusion
64 . . . bent portion
65 . . . butting portion
66 . . . first locking surface
70 . . . outer conductor
71 . . . crimping portion
72 . . . outer peripheral side locking portion
73 . . . locking protrusion
80 . . . outer conductor
81 . . . crimping portion
82 . . . outer peripheral side locking portion
83 . . . base portion
84 . . . locking protrusion
85 fold line
86 . . . first locking surface

1. A shielded electrically conductive path, comprising:
a shielded cable including an insulation coating surrounding a core wire, a shield layer surrounding the insulation coating and a sheath surrounding the shield layer;
a sleeve surrounding an exposed part extending forward of the sheath, out of the shield layer, the sleeve being crimped to an outer peripheral surface of the insulation coating; and
a shield terminal including an outer conductor,
a crimping portion in the form of an open barrel formed in a rear end part of the outer conductor being crimped to the sleeve while surrounding the sleeve and a region behind the sleeve, out of the insulation coating,
an inner peripheral side locking portion and an outer peripheral side locking portion being formed in a region covering the insulation coating, out of the crimping portion,
the inner peripheral side locking portion being located more radially inward than a region surrounding the sleeve, out of the crimping portion, and
the outer peripheral side locking portion being locked to the inner peripheral side locking portion while being accommodated in a recess in an outer peripheral surface of the inner peripheral side locking portion.

2. The shielded electrically conductive path of claim 1, wherein the crimping portion is formed with a retaining portion arranged at a position in contact with the sleeve from behind or closely facing the sleeve from behind.

3. The shielded electrically conductive path of claim 2, wherein the retaining portion continuously extends over at least more than a semiperimeter in a circumferential direction.

4. The shielded electrically conductive path of claim 2, wherein the inner peripheral side locking portion is formed in the retaining portion.

5. The shielded electrically conductive path of claim 1, wherein a depth of the recess is equal to or larger than a plate thickness of the crimping portion.

6. The shielded electrically conductive path of claim 1, wherein:
one of the inner peripheral side locking portion and the outer peripheral side locking portion is formed with a locking hole, and
the other of the inner peripheral side locking portion and the outer peripheral side locking portion is formed with a locking protrusion to be locked into the locking hole.

7. The shielded electrically conductive path of claim 6, wherein an opening dimension in a front-rear direction of the locking hole is set to be larger than a dimension in the front-rear direction of the locking protrusion.

8. The shielded electrically conductive path of claim 6, wherein an opening dimension in a circumferential direction of the locking hole is set to be larger than a dimension in the circumferential direction of the locking protrusion.

9. The shielded electrically conductive path of claim 6, wherein:
the locking hole is formed in the inner peripheral side locking portion, and
the locking protrusion is formed on the outer peripheral side locking portion.

10. The shielded electrically conductive path of claim 6, wherein the locking protrusion is shaped by bending a part of the inner peripheral side locking portion or the outer peripheral side locking portion into a folded shape.

11. The shielded electrically conductive path of claim 6, wherein the locking protrusion is shaped by cutting and raising a part of the inner peripheral side locking portion or the outer peripheral side locking portion in a plate thickness direction.

12. The shielded electrically conductive path of claim 6, wherein the locking protrusion is shaped by bending the inner peripheral side locking portion or the outer peripheral side locking portion along a fold line in a circumferential direction.
